(19) United States
(12) Patent Application Publication
(10) Pub. No.: US 2009/0065509 A1
(43) Pub. Date: Mar. 12, 2009

(54) Collapsible cookware

(75) Inventor: Troy Schuler, Rancho Cucamonga, CA (US)

Correspondence Address: BIRCH STEWART KOLASCH & BIRCH, PO BOX 747, FALLS CHURCH, VA, 22040-0747, US

(73) Assignee: Bradshaw International, Inc., Rancho Cucamong, CA (US)

(21) Appl. No.: 11/896,918

(22) Filed: Sep. 6, 2007

(51) Int. Cl. A47J 27/00; B65D 8/14

(52) U.S. Cl. 220/573.1; 220/8

(57) ABSTRACT

Collapsible cookware is provided. The collapsible cookware includes an upper member having a first opening and a second opening located below the first opening, the upper member being substantially rigid, and a lower member having a third opening located adjacent and connected to the second opening and a bottom portion, the lower member having a substantially constant thickness between the third opening and the bottom portion, wherein the lower member is substantially flexible such that the lower member is collapsible upwards towards the upper member.

### BACKGROUND OF THE INVENTION

1. Field of the Invention

The present invention is directed generally to cookware, such as measuring cups, colanders, and strainers, and more particularly, collapsible cookware.

2. Description of Related Art

Heretofore, collapsible cookware have been provide using one of three different approaches including separate members that are telescopically connected based on sizes of the openings or connection elements that engage/disengage; a collapsible wall that is generally rigid, but includes hinged portions of thinner material to allow the wall to bend; and a collapsible wall that has upper and lower rigid portions connected by an intermediate portion that is flexible, such that when the wall is collapsed, the intermediate portion is reverse folded against either the upper or lower portion.

Each one of these approaches suffer from various drawbacks, such as, for example, requiring complicated or unreliable connection members to hold telescoping members together, requiring a complicated manufacturing process to make hinged portions of substantially thinner material than the surrounding material, or requiring complicated manufacturing processes to provide regions of rigidity separated by regions of the flexible intermediate portions.

### BRIEF SUMMARY OF THE INVENTION

In order to overcome the above mentioned drawbacks of conventional collapsible cookware, a simpler, more easily manufacturable cookware is provided that includes at least an upper member that is substantially rigid and a lower member that is substantially flexible, wherein the lower member has a substantially uniform wall thickness.

Because the lower member has a substantially uniform wall thickness, the manufacturing molds can be simplified.

Furthermore, because the lower member is formed of a substantially flexible material, simple connection techniques can be utilized to connect the upper member and lower member, thereby avoiding the unnecessarily complicated connection mechanisms of telescoping members.

According to principles of the present invention, a collapsible cookware including an upper member having a first opening and a second opening located below the first opening, the upper member being substantially rigid, and a lower member having a third opening located adjacent and connected to the second opening and a bottom portion, the lower member having a substantially constant thickness between the third opening and the bottom portion, wherein the lower member is substantially flexible such that the lower member is collapsible upwards towards the upper member, is provided.

In a further aspect, the connection of the lower member to the upper member may define a fold line of the collapsible cookware.

In another aspect, the lower member may indicate a first measurable amount and the combination of the upper member and lower member may indicate a second measurable amount.

In still another aspect, the lower member may include a plurality of through holes. In addition, the upper member may include a plurality of though holes. The plurality of through holes of the upper member and the plurality of through holes of the lower member may be arranged in a regular pattern around the upper member and lower member, respectively. In this particular configuration, the cookware may be one of a colander and a strainer.

In a different aspect, the cookware may be a measuring cup.

In yet another aspect, the upper body may include a flange around the first opening. The flange may include a pair of graspable handles located on opposite sides of the first opening. In addition, with or without the graspable handles, the cookware may also include at least one handle pivotally connected to the flange. The at least one handle may include a first handle portion pivotally connected to the flange and a second handle portion pivotally connected to the flange.

In yet another aspect, the bottom portion may include a rim extending away from the third opening.

In still another aspect, one of the upper member and the lower member may include a tongue and the other of the upper member and the lower member may include a groove configured to receive the tongue, the tongue and groove cooperating to connect the lower member to the upper member.

According to principles of the present invention, a set of stackable cookware is provided. The set of stackable cookware includes a plurality of collapsible cookware, each collapsible cookware having an upper member including a first opening and a second opening located below the first opening, the upper member being substantially rigid, and a lower member having a third opening located adjacent and connected to the second opening and a bottom portion, the lower member having a substantially constant thickness between the third opening and the bottom portion, wherein the lower member is substantially flexible such that the lower member is collapsible upwards towards the upper member.

In a further aspect, the plurality of collapsible cookware may include at least a large collapsible cookware, an intermediate collapsible cookware being locatable in the large collapsible cookware, and a small collapsible cookware being locatable in the intermediate collapsible cookware.

In yet a further aspect, the large collapsible cookware may include a handle having a recess located in an end distal the upper member, the intermediate collapsible cookware may include a handle having a recess portion locate in an end distal the upper member and a boss portion opposite the recess portion at the end distal the upper member, the boss portion being locatable in the recess of the large collapsible cookware, and the small collapsible cookware may include a handle having a boss portion at an end distal the upper member, the boss portion being locatable in the recess of the intermediate collapsible cookware.

In a different aspect, the plurality of collapsible cookware may be one of measuring cups, colanders, and strainers.

According to principles of the present invention, a cookware including a first body portion having a first opening, a second opening located beneath the first opening, and a first sidewall extending from the first opening to the second opening, the first body portion being formed of a substantially rigid plastic material, and a second body portion having a third opening, a bottom portion, and a second sidewall extending between the third opening and the bottom portion, the second sidewall having a plurality of through holes formed therein, and the second body portion being formed of a substantially flexible elastomeric material such that the second body portion is collapsible upwards into the second opening of the first body portion, is provided.

In another aspect, the lower member has a substantially constant thickness between the third opening and the bottom portion

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 is a top view of a collapsible cookware according to a first exemplary embodiment of the invention;

FIG. 2 is a side view of the cookware of FIG. 1;

FIG. 3 is a cross-sectional view taken along line III-III of the cookware of FIG. 1 and FIG. 3A is a call-out showing a connection between the upper member and lower member;

FIG. 4A is a schematic view showing a plurality of cookware according to the first exemplary embodiment in a stacked relationship and FIG. 4B is an exploded view of plurality of cookware shown in FIG. 4A;

FIG. 5 is a top view of a collapsible cookware according to a second exemplary embodiment of the present invention;

FIG. 6 is a cross-sectional view taken along line VI-VI of the cookware of FIG. 5;

FIG. 7 is a schematic cross-sectional view showing the cookware of FIG. 5 in a collapsed state;

FIG. 8 is a top view of a collapsible cookware according to a third exemplary embodiment of the present invention;

FIG. 9 is a top view of the cookware of FIG. 8 with the handles in an open position;

FIG. 10 is a side view of the cookware of FIG. 9;

FIG. 11 is a cross-section view taken along line XI-XI of the cookware of FIG. 8; and

FIG. 12 is a schematic cross-sectional view showing the cookware of FIG. 8 in a collapsed state.

### DETAILED DESCRIPTION OF THE INVENTION

Reference will now be made in detail to the preferred embodiments of the present invention, examples of which are illustrated in the accompanying drawings. In the following description, the same terms and reference numerals will be used for the same parts, with the exception that the first number is advanced.

The present invention is generally directed to collapsible cookware, such as, but not limited to, measuring cups, colanders, and strainers. The collapsible cookware is formed as a two-piece construction having an upper member or first body portion and a lower member or second body portion connected thereto. The combination of the upper member and lower member provides a collapsible cookware that can used for holding/measuring fluids or solids, and/or draining/separating solids from other solids or fluids. Generally the combination of the upper member and lower member has a circular bowl shape although other shapes are equally applicable.

To provide collapsible cookware, the upper member may be made of a substantially rigid material when compared to the lower member, preferably a plastic or rigid elastomer, while the lower member is made of a flexible material, preferably, an elastomer including silicone. In this configuration, the lower member is sufficiently flexible to allow the lower member to collapse towards the upper member, thereby requiring less space. For example, the lower member may be configured to be so flexible so as to not be able to support the upper member by itself. If more than one collapsible cookware is provided, such as, for example, a plurality of measuring cups, each of the collapsible cookware can be configured so that they are stackable together.

Depending on the intended use of the collapsible cookware, the lower member can include a plurality of through holes for assisting in draining/straining. Similarly, the upper member can also be provided with a plurality of through holes to further improve draining/straining. Alternatively, the lower member may be a solid construction so that it can hold fluids and/or solids.

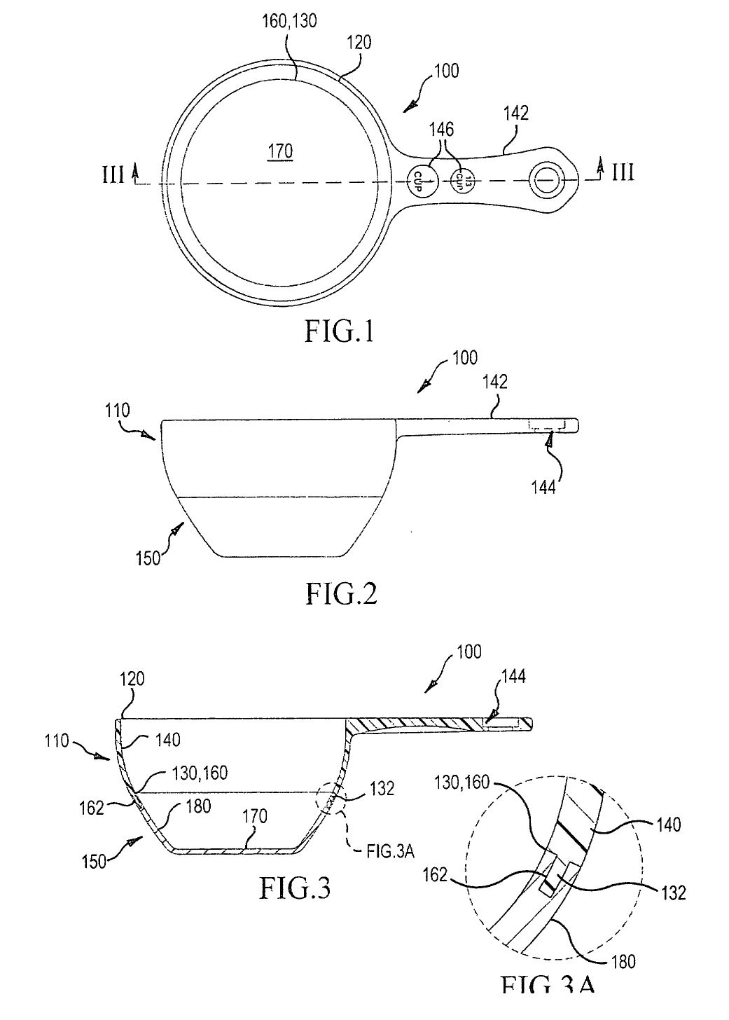

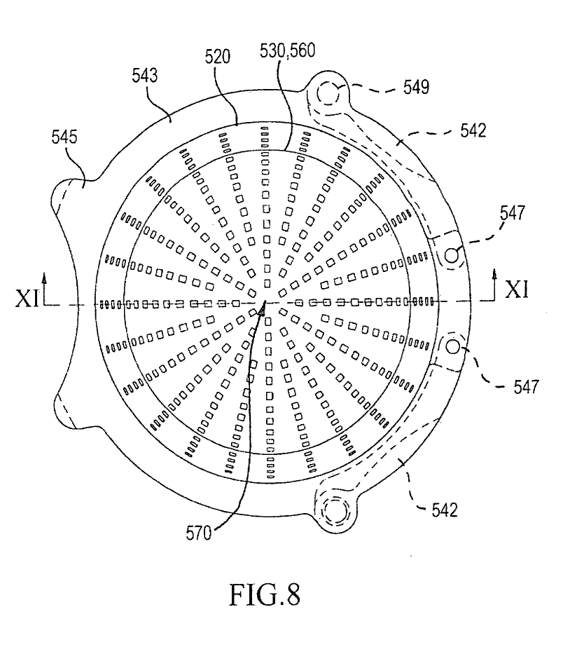

Having generally described some of the features of the present invention, these features will be further described with respect to measuring cups, as shown in FIGS. 1-4B, to a colander, as shown in FIGS. 5-7, and to a strainer, as shown in FIGS. 8-12. It is understood that the present invention is not limited to just these subsets of collapsible cookware, but are merely representative of various applications of the present invention to collapsible cookware.

FIGS. 1-3 show a collapsible cookware 100 according to a first exemplary embodiment of the present invention. In particular, the collapsible cookware 100 includes a first body portion or upper member 110 having a first opening 120, a second opening 130 located below the first opening 120, and a first sidewall 140 extending between the first opening 120 and the second opening 130. The collapsible cookware 100 also includes a second body portion or lower member 150 having a third opening 160 located adjacent and connected to the second opening 130, a bottom portion 170, and a second sidewall 180 extending between the third opening 160 and the bottom portion 170. The openings 120, 130 and first sidewall 140 of the upper member 110, and the opening 160, second sidewall 180, and bottom portion 170 of the lower member 150 assist in defining the interior shape of the collapsible cookware 100.

While the first sidewall 140 may have either a substantially constant thickness or a variable thickness between the first and second openings 120, 130, it is preferable that the second sidewall 180 have a substantially constant thickness between the third opening 160 and the bottom portion 170. By providing a substantially constant thickness for the second sidewall 180, the lower member is less likely to stretch when used as a measuring cup. Furthermore, less complicated molds and manufacturing processes are required to provide a substantially constant thickness as opposed to providing thin hinge portions/intermediate flexible portions used to manufacture conventional collapsible cookware.

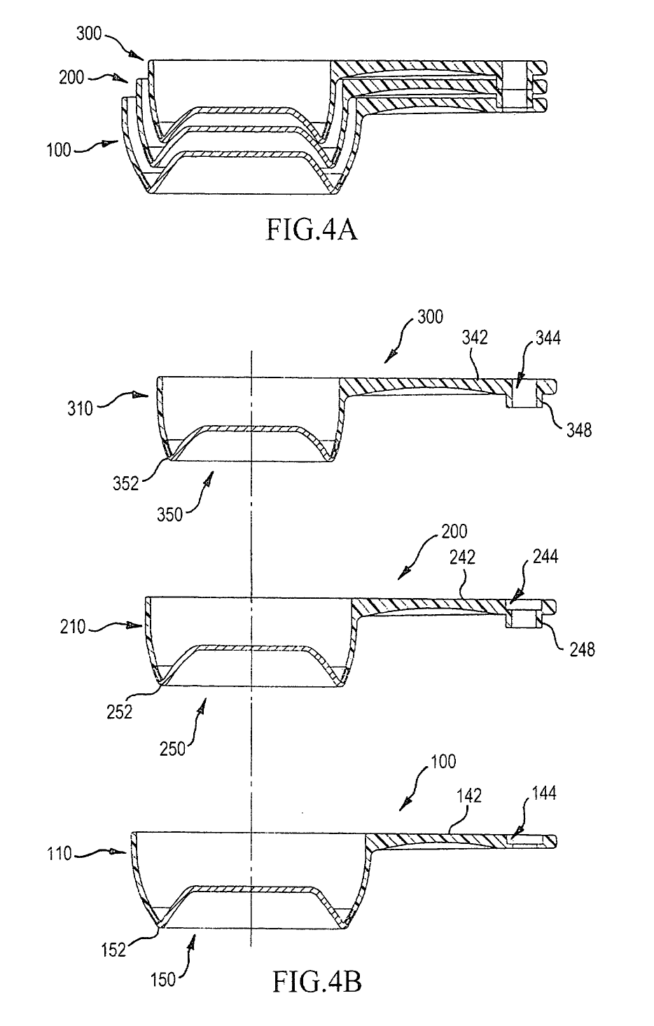

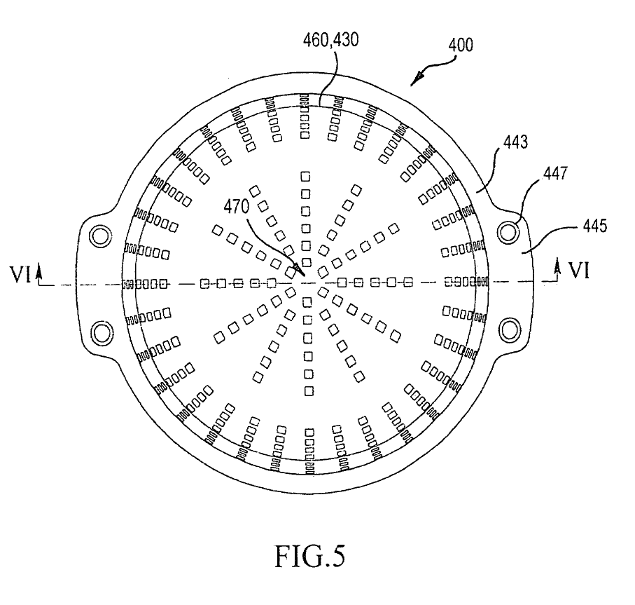

Because of the connection of the lower member 150 to the upper member 110, a fold line 152 (FIG. 4B) of the collapsible cookware can be provided and used to control the height of the collapsible cookware in the collapsed position. As best seen in FIG. 3A, the upper member 110 may have a tongue 132 formed at or near the second opening 130 that cooperates with a groove 162 formed in the lower member 150. The groove 162 may encircle the third opening 160. During assembly, the groove 162 is pressed over the tongue 132 to connect the upper member 110 to the lower member 150. It is understood, that the tongue 132 and groove 162 can be switched. Of course, the upper member 110 and lower member 150 can also be injection molded in two consecutive steps, thereby securing the two members together.

If desired, a handle 142 can be formed/connected to the first sidewall 140. The handle 142 may be provided with a recessed portion 144 that may also include a through hole. As shown, the recessed portion 144 is located in a distal end of the handle 142. The recessed portion 144 serves many different purposes including providing a means of hanging the collapsible cookware 100 from a hook to store/display the collapsible cookware 100.

Indicia 146 may be placed on the handle to provide information, such as, for example, the measuring amount of the collapsible cookware 100. For example, the lower member 150 may indicate a first measurable amount, such as, for example, ⅓ cup, and the combination of the upper member 110 and lower member 150 may indicate a second measurable amount, such as, for example, 1 cup, and the indicia 146 may so indicate the two different measurable amounts.

Having just described a first exemplary collapsible cookware 100, FIGS. 4A and 4B show a plurality of collapsible cookware, including a large collapsible cookware 100, an intermediate collapsible cookware 200, and a small collapsible cookware 300. For example, the small collapsible cookware 300 may indicate measurable amounts of ⅛ cup and ½ cup, the intermediate collapsible cookware 200 may indicate measurable amounts of ¼ cup and ¾ cup, and the large collapsible cookware 100 may indicate measurable amounts of ⅓ cup and 1 cup. Similarly numbered parts of the intermediate collapsible cookware 200 and small collapsible cookware 300 have been described with respect to the numbered parts of the large collapsible cookware 100 and are not repeated here.

Even in the collapsed state, the small collapsible cookware 300 is locatable in the intermediate collapsible cookware 200 and the intermediate collapsible cookware 200 is locatable in the large collapsible cookware 100. To further assist in keeping the set of stacked collapsible cookware 100, 200, 300, the handle 342 of the small collapsible cookware 300 may include a boss portion 348 that is locatable within the recessed portion 244 in the handle 242 of the intermediate collapsible cookware 200. The handle 242 of the intermediate collapsible cookware 200 may also include a boss portion 248 that is locatable within the recessed portion 144 of the large collapsible cookware 100. In this configuration, the entire set of collapsible cookware 100, 200, 300 can be stored/displayed on a single hook. The sizes of the recessed portions 144, 244, and the boss portions 248, 348 can be sized to provide a snug fit to assist in keeping the stack of collapsible cookware 100, 200, 300 together.

Having described a first exemplary embodiment of the present invention, which is well suited for providing measuring cups, a second exemplary embodiment of the present invention is shown in FIGS. 5-7. In particular, collapsible cookware 400, which may be a colander, includes a first body portion or upper member 410 having a first opening 420, a second opening 430 located below the first opening 420, and a first sidewall 440 extending between the first opening 420 and the second opening 430. The collapsible cookware 400 also includes a second body portion or lower member 450 having a third opening 460 located adjacent and connected to the second opening 430, a bottom portion 470, and a second sidewall 480 extending between the third opening 460 and the bottom portion 470. The openings 420, 430 and the first sidewall 440 of the upper member 410 and the opening 460, second sidewall 480, and bottom portion 470 of the lower member 450 assist in defining the interior shape of the collapsible cookware 400.

While the first sidewall 440 may have either a substantially constant thickness or a variable thickness between the first and second openings 420, 430, it is preferable that the second sidewall 480 have a substantially constant thickness between the third opening 460 and the bottom portion 470. By providing a substantially constant thickness for the second sidewall 480, the lower member is less likely to stretch when used as a colander. Furthermore, less complicated molds and manufacturing processes are required to provide a substantially constant thickness as opposed to providing thin hinge portions/intermediate flexible portions used to manufacture conventional collapsible cookware.

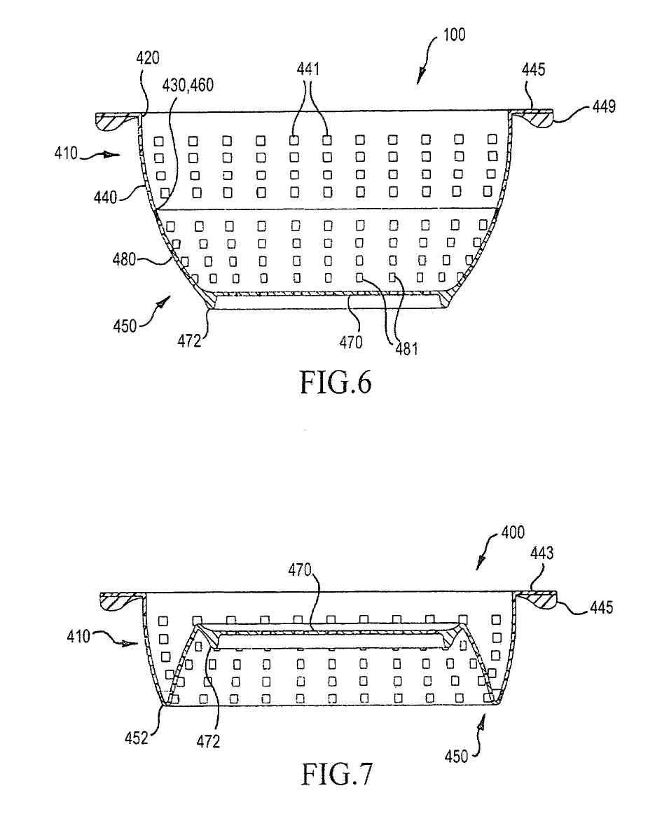

Because of the connection of the lower member 450 to the upper member 410, a fold line 452 of the collapsible cookware can be provided and used to control the height of the collapsible cookware in the collapsed position. As seen in FIG. 6, and similar to the tongue 132 and groove 162 shown in FIG. 3A, the upper member 410 may have a tongue 432 formed at or near the second opening 430 that cooperates with a groove 462 formed in the lower member 450. The groove 462 may encircle the third opening 460. During assembly, the groove 462 is pressed over the tongue 432 to connect the upper member 410 to the lower member 450. It is understood, that the tongue 432 and groove 462 can be switched. Of course, the upper member 410 and lower member 450 can also be injection molded in two consecutive steps, thereby securing the two members together.

In this second exemplary embodiment, the first upper member 410 and lower member 450 include a plurality of through holes 441, 481, respectively. The through holes 441, 481 can have many different shapes such as, but not limited thereto, circles, squares, triangles, and rectangles. Furthermore, the through holes 441, 481 can be arranged in a symmetrical pattern. It is understood that a random pattern of through holes 441, 481 can be provided. It is also understood that the through holes 441 and/or the through holes 481 in the second sidewall 480 are not necessary to the function of a colander and therefore could be eliminated, thereby providing through holes 481 in just the bottom portion 470.

The upper member 410 may include a flange 443 that extends outwards from the first opening 420. As seen in FIG. 5, the flange 443 may include grasping members 445 formed opposite each other. A plurality of through holes 447 are provided in each of the grasping members 445 and may be used to store/display the collapsible cookware 400 from a hook.

An elastomer layer 449, which may be the same elastomer used in the lower member 450, is located on the underside of the flange 443 and grasping members 445. The elastomer layer 449 may assist in the grasping or holding of the collapsible cookware 400 while providing a more comfortable feel.

As best seen in FIG. 6, the bottom 470 of the lower member 450 includes a rim 472 that extends away from the upper member 410. The rim 472 functions as a support member that the colander may rest on. While the support member has been shown as a rim 472, it is understood that the rim could be replaced with a plurality of small supports or eliminated completely.

This second exemplary embodiment, as shown in FIG. 7, is also collapsible like the collapsible cookware 100 shown in FIGS. 1-3. In this manner, the collapsible cookware 400 can save space when stored on a shelf.

A third exemplary embodiment of the present invention is shown in FIGS. 8-12. In particular, collapsible cookware 500, which may be an all-purpose strainer, includes a first body portion or upper member 510 having a first opening 520, a second opening 530 located below the first opening 520, and a first sidewall 540 extending between the first opening 520 and the second opening 530. The collapsible cookware 500 also includes a second body portion or lower member 550 having a third opening 560 located adjacent and connected to the second opening 530, a bottom portion 570, and a second sidewall 580 extending between the third opening 560 and the bottom portion 570. The openings 520, 530 and first sidewall 540 of the upper member and the opening 560, second sidewall 580, and bottom portion 570 of the lower member 550 assist in defining the interior shape of the collapsible cookware 500.

While the first sidewall 540 may have either a substantially constant thickness or a variable thickness between the first and second openings 520, 530, it is preferable that the second sidewall 580 have a substantially constant thickness between the third opening 560 and the bottom portion 570. By providing a substantially constant thickness for the second sidewall 580, the lower member is less likely to stretch when used as a strainer. Furthermore, less complicated molds and manufacturing processes are required to provide a substantially constant thickness as opposed to providing thin hinge portions/intermediate flexible portions used to manufacture conventional collapsible cookware.

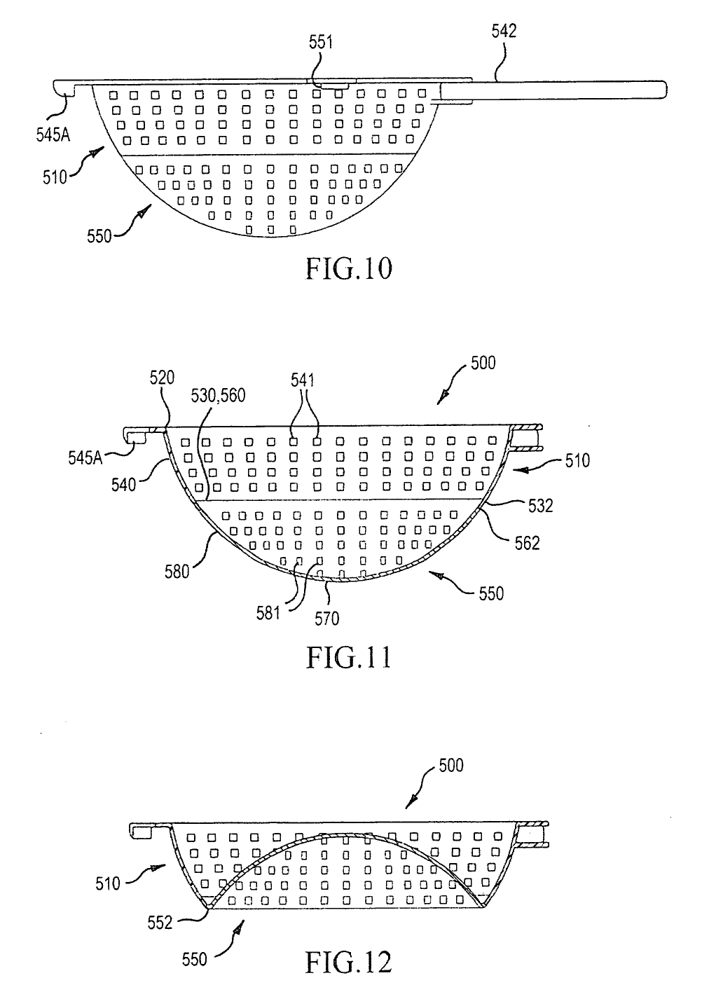

Because of the connection of the lower member 550 to the upper member 510, a fold line 552 of the collapsible cookware can be provided and used to control the height of the collapsible cookware in the collapsed position. As seen in FIG. 11, and similar to the tongue 132 and groove 162 shown in FIG. 3A, the upper member 510 may have a tongue 532 formed at or near the second opening 530 that cooperates with a groove 562 formed in the lower member 550. The groove 562 may encircle the third opening 560. During assembly, the groove 562 is pressed over the tongue 532 to connect the upper member 510 to the lower member 550. It is understood, that the tongue 532 and groove 562 can be switched. Of course, the upper member 510 and lower member 550 can also be injection molded in two consecutive steps, thereby securing the two members together.

In this third exemplary embodiment, the first upper member 510 and lower member 550 include a plurality of through holes 541, 581, respectively. The through holes 541, 581 can have many different shapes such as, but not limited thereto, circles, squares, triangles, and rectangles. Furthermore, the through holes 541, 581 can be arranged in a symmetrical pattern. It is understood that a random pattern of through holes 541, 581 can be provided. It is also understood that the through holes 541 and/or the through holes 581 in the second sidewall 580 are not necessary to the function of a strainer and therefore could be eliminated, thereby providing through holes 581 in just the bottom portion 570.

The upper member 510 may include a flange 543 that extends outwards from the first opening 520. As seen in FIG. 5, the flange 543 may include grasping/supporting members 545 that are configured to be placed on an edge surface, such as an edge surface of a sink. A protruding member 545A is provided that extends downward from the grasping/supporting member, the protruding member 545A assisting in holding the collapsible cookware 500 to the edge surface.

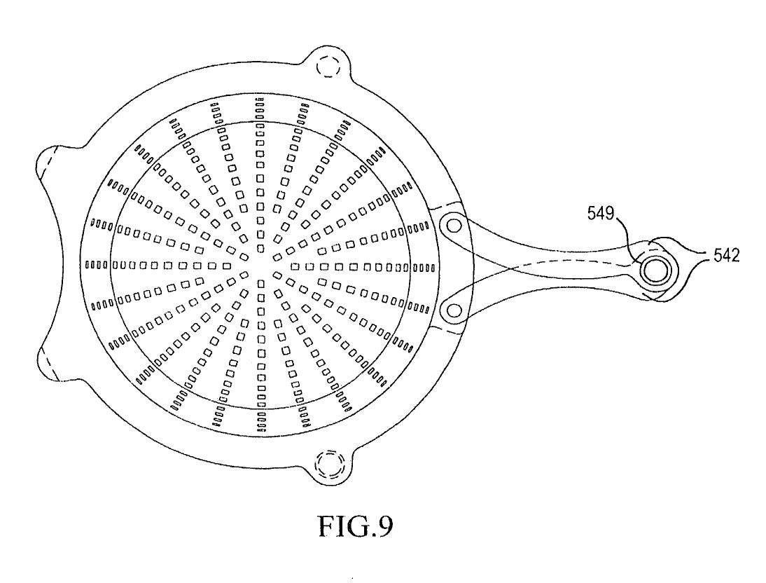

A handle formed of two pivotal handle portions 542 may be located opposite the grasping/supporting members 545. Each handle portion may be mounted to the flange 543 via a pivot hole 547 and the handle portions 542 may be moveable between a first position where they are stored under the flange 543 (FIG. 8) and a second position where the handle portions 542 are brought together (FIGS. 9 and 10). Each handle portion 542 also includes a through hole 549 at an end opposite the pivot hole 547, which allows the collapsible cookware 500 to be hung from a hook for storage/display when the handle portions 542 are in the second position. As best seen in FIG. 10, a stopper 551 is provided beneath the flange 543 to engage a corresponding through hole 549 to lock the handle portion 542 in the first position.

This third exemplary embodiment, as shown in FIG. 11, is also collapsible like the collapsible cookware 100 shown in FIGS. 1-3. In this manner, the collapsible cookware 500 can save space when stored on a shelf.

The invention thus being described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed:

1. A collapsible cookware comprising:
an upper member having a first opening and a second opening located below the first opening, the upper member being substantially rigid; and
a lower member having a third opening located adjacent and connected to the second opening and a bottom portion, the lower member having a substantially constant thickness between the third opening and the bottom portion,
wherein the lower member is substantially flexible such that the lower member is collapsible upwards towards the upper member.

2. The collapsible cookware according to claim 1, wherein the connection of the lower member to the upper member defines a fold line of the collapsible cookware.

3. The collapsible cookware according to claim 1, wherein the lower member indicates a first measurable amount and the combination of the upper member and lower member indicates a second measurable amount.

4. The collapsible cookware according to claim 1, wherein the lower member includes a plurality of through holes.

5. The collapsible cookware according to claim 4, wherein the upper member includes a plurality of though holes.

6. The collapsible cookware according to claim 5, wherein the plurality of through holes of the upper member and the plurality of through holes of the lower member are arranged in a regular pattern around the upper member and lower member, respectively.

7. The collapsible cookware according to claim 4, wherein the cookware is one of a colander and a strainer.

8. The collapsible cookware according to claim 1, wherein the cookware is a measuring cup.

9. The collapsible cookware according to claim 1, wherein the upper body includes a flange around the first opening.

10. The collapsible cookware according to claim 11, wherein the flange includes a pair of graspable handles located on opposite sides of the first opening.

11. The collapsible cookware according to claim 9, further comprising at least one handle pivotally connected to the flange.

12. The collapsible cookware according to claim 11, wherein the at least one handle includes a first handle portion pivotally connected to the flange and a second handle portion pivotally connected to the flange.

13. The collapsible cookware according to claim 1, wherein the bottom portion includes a rim extending away from the third opening.

14. The collapsible cookware according to claim 1, wherein one of the upper member and the lower member includes a tongue and the other of the upper member and the lower member includes a groove configured to receive the tongue, the tongue and groove cooperating to connect the lower member to the upper member.

15. A set of stackable cookware comprising:
a plurality of collapsible cookware, each collapsible cookware including:
an upper member having a first opening and a second opening located below the first opening, the upper member being substantially rigid; and
a lower member having a third opening located adjacent and connected to the second opening and a bottom portion, the lower member having a substantially constant thickness between the third opening and the bottom portion,
wherein the lower member is substantially flexible such that the lower member is collapsible upwards towards the upper member.

16. The set of stackable cookware according to claim 15, wherein the plurality of collapsible cookware includes at least:
a large collapsible cookware;
an intermediate collapsible cookware being locatable in the large collapsible cookware; and
a small collapsible cookware being locatable in the intermediate collapsible cookware.

17. The set of stackable cookware according to claim 16, wherein:
the large collapsible cookware includes a handle having a recess located in an end distal the upper member;
the intermediate collapsible cookware includes a handle having a recess portion locate in an end distal the upper member and a boss portion opposite the recess portion at the end distal the upper member, the boss portion being locatable in the recess of the large collapsible cookware; and
the small collapsible cookware includes a handle having a boss portion at an end distal the upper member, the boss portion being locatable in the recess of the intermediate collapsible cookware.

18. The set of stackable cookware according to claim 15, wherein the plurality of collapsible cookware are one of measuring cups, colanders, and strainers.

19. A collapsible cookware comprising:
a first body portion having a first opening, a second opening located beneath the first opening, and a first sidewall extending from the first opening to the second opening, the first body portion being formed of a substantially rigid plastic material;
a second body portion having a third opening, a bottom portion, and a second sidewall extending between the third opening and the bottom portion, the second sidewall having a plurality of through holes formed therein, and the second body portion being formed of a substantially flexible elastomeric material such that the second body portion is collapsible upwards into the second opening of the first body portion.

20. The collapsible cookware according to claim 19, wherein the lower member has a substantially constant thickness between the third opening and the bottom portion,
